(19) United States
(12) Patent Application Publication
(10) Pub. No.: US 2026/0220333 A1
(43) Pub. Date: Jul. 30, 2026

(54) HYBRIDIZED METHODS FOR PLANNING OF TURNAROUND AND INSPECTION ACTIVITIES

(71) Applicant: SAUDI ARABIAN OIL COMPANY, Dhahran (SA)

(72) Inventors: Rakan H. AL-BELADI, Dhahran (SA); Jhoel O. PEREZ PEREZ, Dhahran (SA); Dinesh C. SHUKLA, Dhahran (SA); Omar T. ALSHAHEEN, Dhahran (SA)

(73) Assignee: SAUDI ARABIAN OIL COMPANY, Dhahran (SA)

(21) Appl. No.: 19/039,583

(22) Filed: Jan. 28, 2025

(51) Int. Cl. G06F 30/27; G06F 111/04; G06N 3/126

(52) U.S. Cl. CPC G06F 30/27; G06N 3/126; G06F 2111/04

(57) ABSTRACT

A computer-implemented method for executing an optimized turnaround and inspection schedule for a hydrocarbon network includes obtaining constraints and parameters related to operations of a plurality of hydrocarbon facilities of the hydrocarbon network, providing the constraints and parameters to a linear programming module and a genetic algorithm module for optimization, optimizing an objective function for a possible turnaround and inspection schedule via the linear programming module and using the constraints and parameters, and modifying solutions for the possible turnaround and inspection schedule via genetic operators in the genetic algorithm module. The method further includes testing for convergence between the linear programming module and the genetic algorithm module, combining the converged solutions of the linear programming module and the genetic algorithm module to generate the optimized turnaround and inspection schedule, and performing maintenance, repairs, and/or inspections on the hydrocarbon facilities according to the optimized turnaround and inspection schedule.

### FIELD OF THE DISCLOSURE

The present disclosure relates generally to maintenance planning and scheduling operations for hydrocarbon facilities and, more particularly, to using hybridized machine learning methods and systems to optimize turnaround and inspection activities.

### BACKGROUND OF THE DISCLOSURE

During hydrocarbon refinement and distribution operations, the planning and performance of plant downtime may directly affect the efficiency, safety, reliability, and profitability of the entire production network. One major component of planning plant downtime is the development of a turnaround and inspection (T&I) activity plan. T&I activities may include several days, weeks, or months of downtime for a part, or all, of a hydrocarbon refinery or other facility. During this downtime, the facility can be taken offline from the overall production network for maintenance, inspections, and repairs of the facility of interest. These T&I activities can prevent unplanned downtimes for maintenance during regular operations, and can extend the lifetime and productivity of the overall production system. However, for every day of this offline time, the facility can be considered unprofitable, and can reduce the readiness of overall production network. If the planning and performance of T&I activities is not coordinated and performed carefully, oil and gas companies can face losses of efficiency and profitability.

The planning of T&I schedules is intended to reduce hydrocarbon plant downtimes through optimized timing and sequencing across various facilities. In current practice, extensive discussion and data collection can occur between all plants of the overall production network, including oil, gas, and natural gas liquid plants such as terminals, refineries, and distribution and pipeline facilities. The optimization of the T&I schedule can thus minimize T&I conflicts between facilities of shared function, and can ensure sustainable supply of all hydrocarbon products to all online facilities. Once the overall T&I schedule has been developed and discussed, T&I coordination can be carried out via commercially-available and shared scheduling and production software. These planning activities can occur as early as three years prior to the downtime to be scheduled, such that an extended and evolving schedule can be developed over a number of months. However, this planning process can involve significant time and effort from a number of senior-level operations staff, and can still be subject to human error, oversight issues, and flawed data processing.

Accordingly, systems and methods for automating turnaround and inspection activities in hydrocarbon facilities are desirable to optimize efficiency and profitability of an overall hydrocarbon production network.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

In an embodiment of the present disclosure, a computer-implemented method for executing an optimized turnaround and inspection schedule for a hydrocarbon network includes obtaining constraints and parameters related to operations of a plurality of hydrocarbon facilities of the hydrocarbon network, providing the constraints and parameters to a linear programming module and a genetic algorithm module for optimization, optimizing an objective function for a possible turnaround and inspection schedule via the linear programming module and using the constraints and parameters, and modifying solutions for the possible turnaround and inspection schedule via genetic operators in the genetic algorithm module. The method further includes testing for convergence between the linear programming module and the genetic algorithm module, combining the converged solutions of the linear programming module and the genetic algorithm module to generate the optimized turnaround and inspection schedule, and performing maintenance, repairs, and/or inspections on the hydrocarbon facilities according to the optimized turnaround and inspection schedule.

In another embodiment, a system for constructing an optimized turnaround and inspection schedule for a hydrocarbon network includes a turnaround and inspection optimization engine operable to construct an optimized turnaround and inspection schedule from input data including constraints and parameters of a plurality of facilities of the hydrocarbon network. The turnaround and inspection optimization engine includes a linear programming module operable to optimize an objective function using the constraints and parameters of the plurality of facilities, a genetic algorithm module operable to iteratively improve possible solutions to the optimized turnaround and inspection schedule using genetic operators, a convergence module operable to test for convergence in each of the linear programming module and the genetic algorithm module, and a result integration module operable to combine solutions from the linear programming module and the genetic algorithm module to construct the optimized turnaround and inspection schedule.

In a further embodiment, a computer-implemented method for executing an optimized turnaround and inspection schedule for a hydrocarbon network includes requesting facility information for a plurality of hydrocarbon facilities of the hydrocarbon network from local operators of each facility, the facility information including possible constraints and parameters for creating the optimized turnaround and inspection schedule, querying an optimization model using the possible constraints and parameters to begin an optimization process on a linear programming module and a genetic algorithm module, constructing the optimized turnaround and inspection schedule from a combination of solutions found via the linear programming module and the genetic algorithm module, and executing the optimized turnaround and inspection schedule on the hydrocarbon network via the local operators of each facility to perform repairs, maintenance, and inspections.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic view of an example system for optimizing a turnaround and inspection schedule for a hydrocarbon network.

FIG. 2 is a schematic view of an example system including interfacing between a turnaround and inspection optimization engine and unified operations application.

FIG. 3 is a schematic view of the unified operations application for performance of the scheduling process using the turnaround and inspection optimization engine.

FIG. 4 illustrates an example workflow for planning, creating, and executing a turnaround and inspection plan using the unified operations application and turnaround and inspection optimization engine.

FIG. 5 illustrates a method for constructing an optimized turnaround and inspection schedule for a hydrocarbon network.

FIG. 6 illustrates a method for planning and executing the optimized turnaround and inspection schedule for a hydrocarbon network using a unified operations application.

FIG. 7 illustrates one example of a computer system that can be employed to execute one or more embodiments of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to maintenance planning and scheduling operations for hydrocarbon facilities and, more particularly, to using hybridized machine learning methods and systems to optimize turnaround and inspection activities. Embodiments disclosed herein include systems and methods for constructing and executing optimized turnaround and inspection schedules for a hydrocarbon network. The optimized turnaround and inspection schedule can account for constraints and parameters of each facility in the hydrocarbon network to optimize an objection function using linear programming algorithms. The disclosed systems and methods can further employ genetic algorithms to modify and mutate possible optimized solutions, such that unexpected and diverse solutions can be tested alongside traditional optimizations. The hybridized approach using linear programming and genetic algorithms can utilize parallelization to provide rapid optimization and independent analysis between the varied algorithms. In the disclosed embodiments, the hybridized approach can enable communication between these algorithms to provide enhanced initial conditions and improve upon the parallel optimization processes using data from the varied algorithms.

The disclosed systems and methods can further include a unified operations application that enables the creation of users, submission of data, interfacing with and querying of the optimization model, validation of results, approval by directors and planning personnel, and rollout of the optimized turnaround and inspection schedule. The unified operations application can accordingly provide a central repository for each step of the construction and execution of the optimized turnaround and inspection schedule. The disclosed systems and methods can enable the use of a hierarchical workflow that provides various user responsibilities within a shared application, thus ensuring uniform data entry, approval, and execution processes. Through the combination of the hybridized machine learning approach to optimizing the turnaround and inspection schedule and the centralization of the unified operations application, the disclosed methods and systems can improve the optimization process, facilitate network-wide uniformity, and significantly reduce both the time taken and the effort required to create and implement an optimized turnaround and inspection schedule. As such, the disclosed embodiments can further reduce downtime of the hydrocarbon network, increase profitability of the facilities therein, and maintain constant communication between planning officers, director-level staff, and local facility operators.

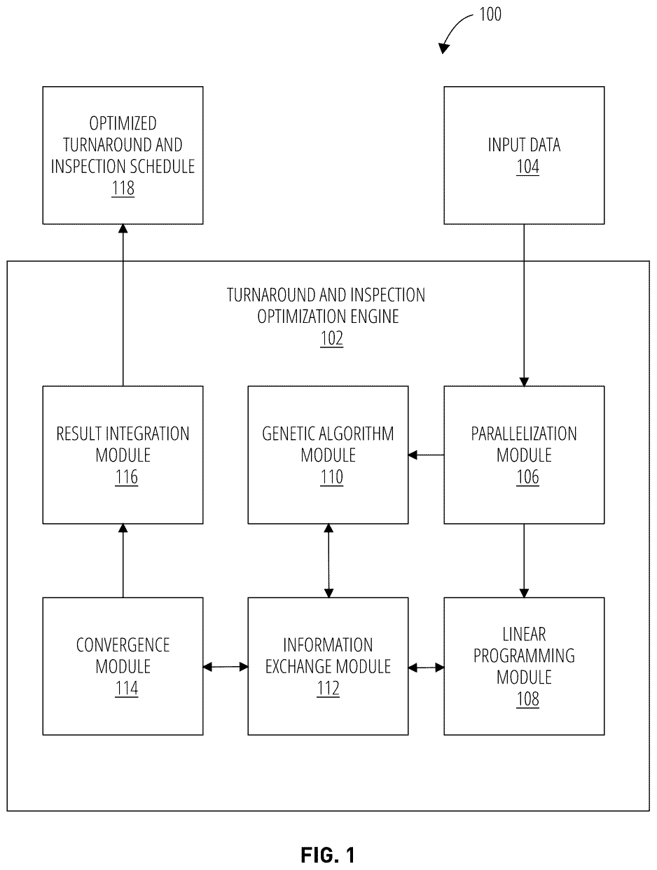

FIG. 1 is a schematic view of an example system 100 for optimizing a turnaround and inspection schedule for a hydrocarbon network. The turnaround and inspection schedule can provide planned facility downtime for repairs, maintenance, and inspections for each facility of the hydrocarbon network. The system 100 can include a turnaround and inspection optimization engine 102 that is operable to perform a hybridized optimization process for constructing the turnaround and inspection of the hydrocarbon network based upon provided input data 104. The input data 104 can include a plurality of constraints, parameters, and other data related to each of the facilities in the hydrocarbon network. These constraints and parameters can include, but are not limited to, estimated capacity, estimated downtime, connected facilities, necessary repair operations, operator availability, facility purpose, or any combination thereof. In some embodiments, logical constraints can be included in input data 104, such that considerations can be made regarding two or more specific facilities requiring aligned statuses, the seasonality of specific products, pre-existing repair requests, or any combination thereof. The input data 104 can be received within the turnaround and inspection optimization engine 102 for use in the hybridized optimization process. In some embodiments, the input data 104 can be received by a parallelization module 106, such that the input data 104 can be directed to both a linear programming module 108 and a genetic algorithm module 110 simultaneously.

The linear programming module 108 can utilize an objective function that is set to optimize one or more aspects of the downtime for the hydrocarbon network, such as minimizing estimated loss of revenue, controlling gross margins of the hydrocarbon network, limiting overlap between similar facilities, aligning with seasonal products and operations, or prioritizing repair operations to prevent further unexpected downtime. In some embodiments, the objective function can minimize any overlapping downtime between facilities of the hydrocarbon network, while further minimizing the delta between supply and demand of oil and gas to maximize gross margins. The linear programming module 108 can receive the constraints and parameters of the hydrocarbon network as inputs for this optimization process, and can systematically determine an optimal shutdown schedule for the desired objective function. The genetic algorithm module 110 can generate an initial population of solutions for the planned turnaround and inspection, and can evaluate each solution based upon a desired outcome. Following this evaluation, the genetic algorithm module 110 can utilize machine learning and genetic operators, such as selection, crossover, and mutation, to construct new solutions, or “generations”. Each of these new generations can be iterative improvements from the initial population, and the genetic operators can provide diverse improvements to the schedule that can be counter-intuitive or different from established guidance. Using the parallelization module 106, the turnaround and inspection optimization engine 102 can perform optimization using both the linear programming module 108 and the genetic algorithm module 110 simultaneously to perform the hybridized approach to optimization. The parallelization module 106 can further reduce the computational time required for this optimization, as the computational workload can be divided between a number of discrete or virtual processors.

During the simultaneous optimization processes of the linear programming module 108 and genetic algorithm module 110, the turnaround and inspection optimization engine 102 can facilitate communication between these modules via an information exchange module 112. The information exchange module 112 can receive and transmit data from the linear programming module 108 to the genetic algorithm module 110, or vice-versa, such that the respective solutions can improve upon each other. For example, the information exchange module 112 can provide feasible solutions from the linear programming module 108 to the genetic algorithm module 110, such that an updated population that includes partially-optimized results can be mutated further. In further examples, the information exchange module 112 can provide improved or diversified solutions from the genetic algorithm module 110 to the linear programming module 108 to refine the optimization process and provide novel starting points for the reducing the objective function in the linear programming module 108. As such, the parallelized, hybridized approach can iteratively improve upon itself during the optimization process.

In some embodiments, the turnaround and inspection optimization engine 102 can include a convergence module 114 operable to test solutions of the linear programming module 108 and genetic algorithm module 110 for convergence during the optimization process. The convergence module 114 can test for converged solutions, an iteration count threshold, or satisfaction of a desired design objective. The convergence module 114 can receive this information from the information exchange module 112 during the exchanges between the linear programming module 108 and genetic algorithm module 110, such that the solutions can be tested for convergence as they are provided between the optimization modules. Upon convergence of both solutions from the linear programming module 108 and the genetic algorithm module 110, the turnaround and inspection optimization engine 102 can utilize a result integration module 116 to combine the optimized solutions. The result integration module 116 can accordingly construct an optimized turnaround and inspection schedule 118 from the combined solutions of the linear programming module 108 and genetic algorithm module 110, thus leveraging the optimization of objective function-based algorithms and machine learning genetic operators to provide an optimal solution to the turnaround and inspection of the hydrocarbon network. In some embodiments, the result integration module 116 can compare the solutions from each module to determine if one solution significantly outperforms the other module with respect to results or constraint adherence. In these embodiments, the result integration module 116 can directly the select the solution from the outperforming module as the optimized solution. In further embodiments, however, the solution from the linear programming module 108 can be chosen for a stricter, constraint-based foundation, while the solution from the genetic algorithm module 110 can be utilized to optimize less-constrained tasks. In these embodiments, each task within the optimized turnaround and inspection schedule 118 can be considered critical or non-critical, such that the solution from the linear programming module 108 can control any critical tasks, while the solution from the genetic algorithm module 110 can control any non-critical tasks based upon secondary priorities. As such, the result integration module 116 can adjust and finalize the optimized turnaround and inspection schedule 118 using genetic algorithm results to adapt to disruptions while using linear programming results to maintain a stable underlying solution.

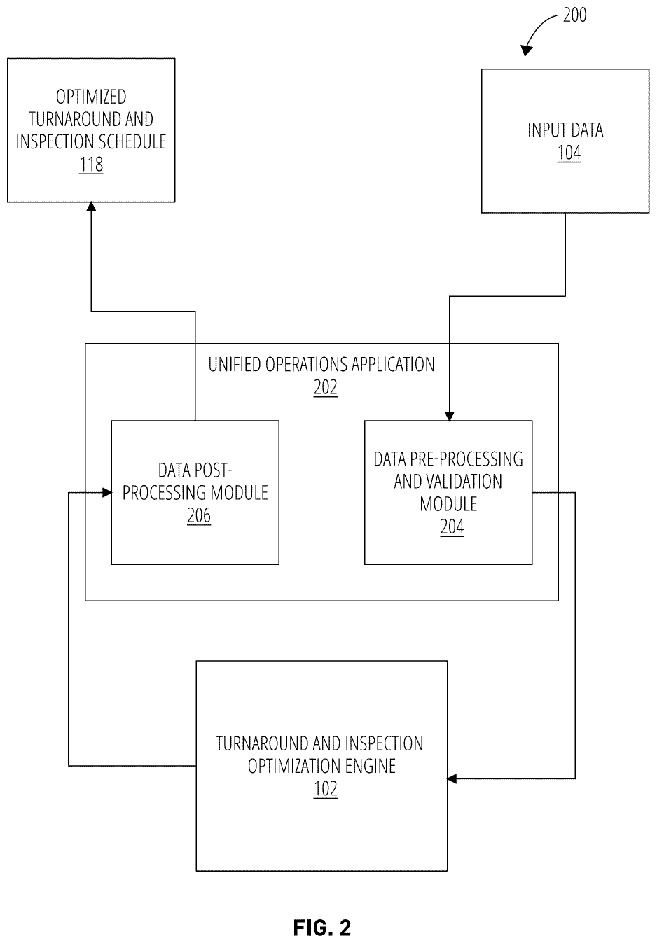

FIG. 2 is a schematic view of an example system 200 including interfacing between a turnaround and inspection optimization engine 102 and unified operations application 202. The unified operations application 202 can be a cloud-based application that enables users and operators throughout the hydrocarbon network to provide the input data 104, review and validate the data, query the turnaround and inspection optimization engine 102, approve, and view the optimized turnaround and inspection schedule 118. The unified operations application 202 can receive the input data 104 from local operators at each facility of the hydrocarbon network, such that each facility can have representatives submit the constraints and parameters relevant to their facility. The unified operations application 202 can accordingly provide unified data collection across the hydrocarbon network, and can store all relevant data in a centralized repository for access and use. The unified operations application 202 can be interfaced with the turnaround and inspection optimization engine 102, such that the compiled data can be seamlessly transferred to the turnaround and inspection optimization engine 102 for performance of the optimization processes outline in FIG. 1.

The unified operations application 202 can include a data pre-processing and validation module 204 that enables director-level or planning operators to review the submitted input data 104, check for validity of the provided estimates, and coordinate review of any spurious values. The pre-processed and validated data can then be provided to the turnaround and inspection optimization engine 102 from the unified operations application 202 to ensure accurate, quality data is used to perform the optimization processes. Similarly, following the generation of the optimized turnaround and inspection schedule 118, the turnaround and inspection optimization engine 102 can provide the optimized turnaround and inspection schedule 118 to a data post-processing module 206 of the unified operations application 202. The data post-processing module 206 can flag any events within the optimized turnaround and inspection schedule 118 that are altered from the proposed schedule and identify the reasoning behind the changes. These flagged events can be reviewed by director-level and planning users of the unified operations application 202 to ensure that the changes are valid, and do not interfere with any of the supplied constraints for the hydrocarbon network. Following this post-processing in the data post-processing module 206, the optimized turnaround and inspection schedule 118 can be provided to any users of the unified operations application 202 for execution of the optimized turnaround and inspection schedule 118.

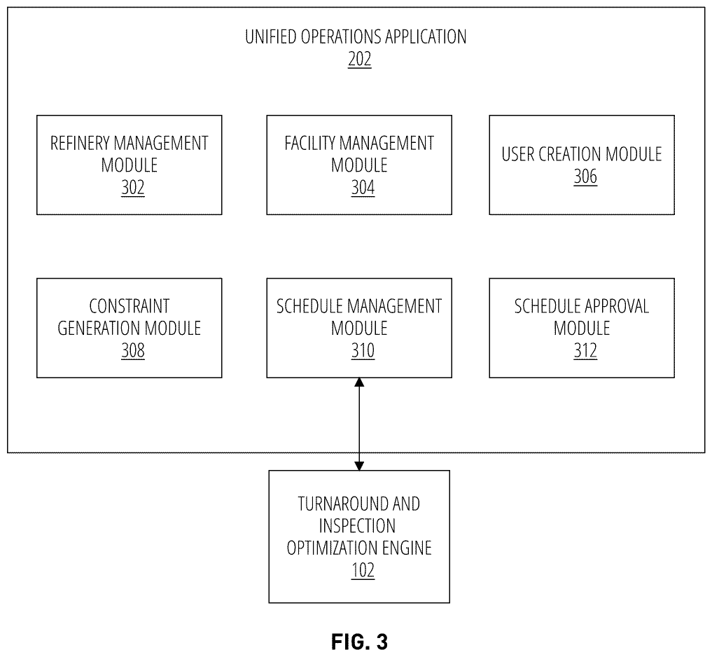

FIG. 3 is a schematic view of the unified operations application 202 for performance of the scheduling process using the turnaround and inspection optimization engine 102. As discussed above, the unified operations application 202 can be operable to facilitate communication between operators of the plurality of facilities of the hydrocarbon network, while leveraging the power of the turnaround and inspection optimization engine 102 to provide an optimized turnaround and inspection schedule 118 (FIGS. 1-2). In the disclosed embodiments, the unified operations application 202 can be utilized by one or more oil supply planning and scheduling (OSPAS) operators that oversee the creation and execution of the turnaround and inspection schedule for the hydrocarbon network.

The unified operations application 202 can include a refinery management module 302 operable to create a record of each refinery of the hydrocarbon network for identification within the unified operations application 202. The refinery management module 302 can provide a top level of data structure for the creation of additional users and facilities related to each refinery of the hydrocarbon network. As such, the unified operations application 202 can further include a facility management module 304 operable to create any additional facilities connected to each refinery of the hydrocarbon network. The facility management module 304 can enable the creation of a facility within the data structure that includes the service performed, the capacity of the facility, any connected refineries and facilities, and any proposed or required downtime for said facility. As such, the refinery management module 302 and facility management module 304 can enable the creation of a digital representation of each facility in the hydrocarbon network within the unified operations application 202.

As discussed above, the OSPAS operators can create additional users to be tied to each facility. The unified operations application 202 can accordingly include a user creation module 306 operable to generate user credentials for director-level personnel at each facility. The OSPAS operators can accordingly generate and assign credentials to these director-level personnel to request the submission of the constraints and parameters related to their facility via the constraint generation module 308. In some embodiments, the director-level personnel can utilize the user creation module 306 to generate credentials for local operators at their facility to act as representatives for providing the input data and enacting the eventual turnaround and inspection schedule. Thus, either the director-level operators or the local operators can provide the constraints and parameters to the unified operations application 202 through the constraint generation module 308. The constraint generation module 308 can accordingly compile all of the data provided to the unified operations application 202 from the various users, and can interface with the data pre-processing and validation module 204 of FIG. 2.

The unified operations application 202 can further include a schedule management module 310 that can directly interface with the turnaround and inspection optimization engine 102 to produce the optimized turnaround and inspection schedule 118, as discussed above. The schedule management module 310 can provide this interface to the OSPAS operators, such that the validated data can be provided in a single input to the turnaround and inspection optimization engine 102 from the unified operations application 202. The querying of the turnaround and inspection optimization engine 102 by the OSPAS operators via the schedule management module 310 can begin the optimization process, which can traditionally take several months to complete by OSPAS operators. The turnaround and inspection optimization engine 102 can rapidly provide the optimized turnaround and inspection schedule to the schedule management module 310 for post-processing (e.g., via the data post-processing module 206 of FIG. 2), such that the OSPAS operators can validate the proposed solution.

In some embodiments, the unified operations application 202 can include a schedule approval module 312 operable to provide the optimized turnaround and inspection schedule 118 to the OSPAS and director-level operators for final approval prior to adoption of the schedule. The schedule approval module 312 can enable feedback from the director-level operators regarding any issues their facility may face under this schedule, and the schedule management module 310 can be used to re-query the turnaround and inspection optimization engine 102 to update the solution. Following the approval of these operators in the schedule approval module 312, the unified operations application 202 can enable the viewing and execution of the optimized turnaround and inspection schedule 118 (FIGS. 1-2) by the local operators of each facility in a unified manner.

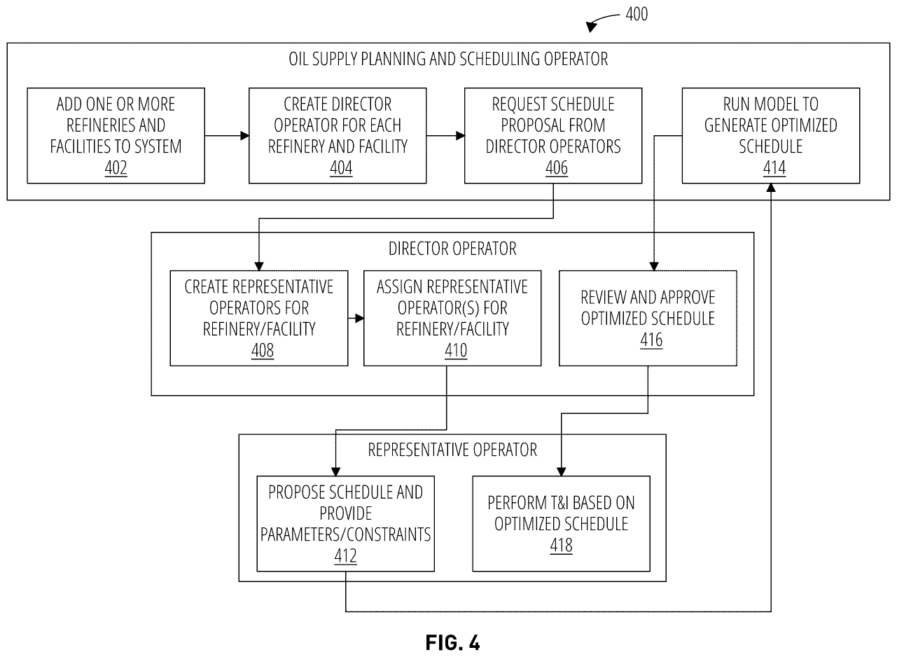

FIG. 4 illustrates an example workflow 400 for planning, creating, and executing a turnaround and inspection schedule using the unified operations application 202 and the turnaround and inspection optimization engine 102 of FIGS. 1-3. The workflow 400 can provide the flow of information and assignments between the OSPAS operators, director-level operators, and representative/local operators within the hydrocarbon network. The workflow 400 can begin at 402 with the addition of one or more refineries or facilities of the hydrocarbon network to the unified operations application 202 of FIGS. 2-3. As discussed above, the addition of the refineries and facilities at 402 can provide a high-level data structure under which each other user and data point can be assigned.

The workflow 400 can continue at 404 with the creation of director operators for each refinery and facility created at 402 by the OSPAS operators. In some embodiments, the creation of director operators at 404 can be performed via the user creation module 306 of the unified operations application 202, as discussed above. The OSPAS operators can create the director operator user credentials at 404 to designate and delegate responsibility over the facility of interest to the leadership of said facility. Following creation of the user credentials for the director-level operators at 404, the OSPAS operators can request a proposed schedule and facility data from the newly created director-level operators within the unified operations application 202 of FIGS. 2-3. The director-level operators can be accordingly notified within the unified operations application 202 with a prompt requesting the submission of facility information.

The workflow 400 can thus continue at 408, wherein the director-level operators can further create user credentials within the unified operations application 202 of FIGS. 2-3 corresponding to one or more representatives within their facility to take the lead on the turnaround and inspection schedule. In some embodiments, these user credentials can be created for the representative/local operators of the facility via the user creation module 306 of the unified operations application 202, as discussed above. In further embodiments, the director operators can create multiple representatives for different sections of the facility, or can create representatives for multiple facilities over which the director operator has oversight. Once the user credentials are created at 408 for the representative/local operators, the workflow 400 can continue at 410 with assigning these representative/local operators as the representative of the facility or section of interest. This assignment at 410 can enable the unified operations application 202 of FIGS. 2-3 to notify the representative/local operators to provide a proposed schedule and any parameters or constraints of the facility of interest.

The workflow 400 can accordingly continue at 412 with the representative/local operator providing a proposed timeframe or schedule for the turnaround and inspection at their facility, as well as any constraints on the facility and parameters such as total capacity. The steps of the workflow 400 involving the director and representative/local operators can be performed for each facility of the hydrocarbon network, such that users and assignments are created across the entire hydrocarbon network. As such, each facility will have one or more representative/local operators providing proposed schedules and parameters/constraints to the OSPAS operators at 412. All the proposed schedules and parameters/constraints can be submitted via the unified operations application 202 of FIGS. 2-3, such the OSPAS operators can have access to a central repository of all possible constraints and an initial schedule for the full hydrocarbon network.

The workflow 400 can continue at 414 with the OSPAS operators compiling all constraints, parameters, and proposed schedules and running an optimization model (e.g., via the turnaround and inspection optimization engine 102) to generate an optimized turnaround and inspection schedule (e.g., the optimized turnaround and inspection schedule 118). The OSPAS operators can utilize the interface between the unified operations application 202 and the turnaround and inspection optimization engine 102, as discussed above, to directly query the turnaround and inspection optimization engine 102 with the compiled information. At 414, the OSPAS operators can query the model, review the optimized schedule, and perform post-processing (e.g., via the data post-processing module 206) of the final schedule. Following generation and validation of the final optimized turnaround and inspection schedule, the workflow 400 can continue at 416 with the OSPAS operators providing the optimized turnaround and inspection schedule to each director-level operator previously established. Each director-level operator can review the proposed optimized turnaround and inspection schedule, ensure that any local constraints are satisfied, and accordingly approve the optimized turnaround and inspection schedule as final, all within the unified operations application 202 of FIGS. 2-3.

Once the final optimized turnaround and inspection schedule is approved, the workflow 400 can continue at 418 with each of the representative/local operators receiving the final optimized turnaround and inspection schedule to perform maintenance, repairs, or inspections using the optimized schedule. The optimized schedule can be distributed to all personnel of all facilities via the unified operations application 202 of FIG. 2, such that all personnel follow the optimized turnaround and inspection schedule to achieve reduced downtime, increased profitability, and proper prioritization of at-risk equipment.

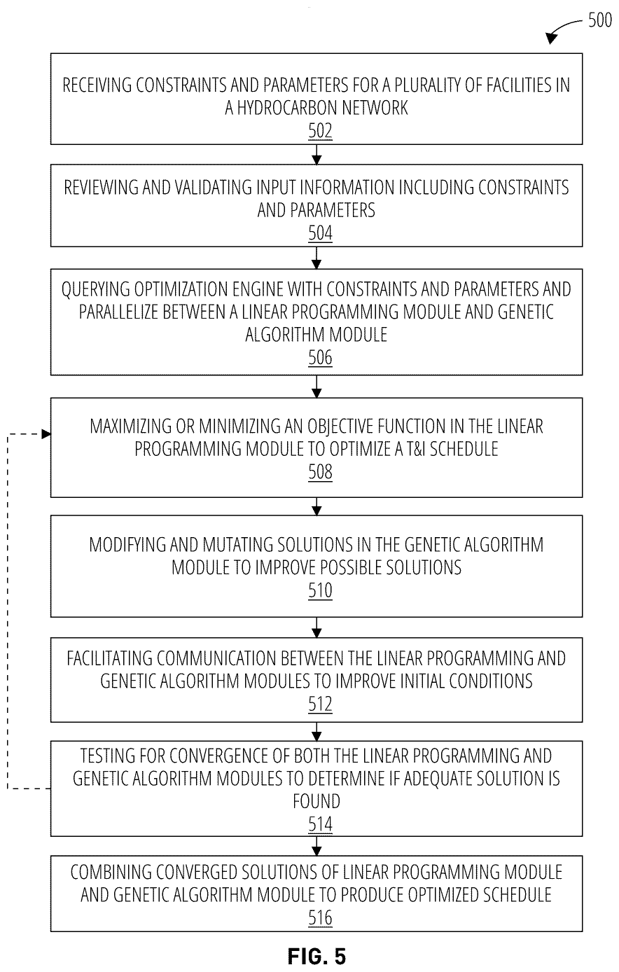

In view of the structural and functional features described above, example methods will be better appreciated with reference to FIG. 5. While, for purposes of simplicity of explanation, the example methods of FIG. 5 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods, and conversely, some actions may be performed that are omitted from the description.

FIG. 5 illustrates a method 500 for constructing an optimized turnaround and inspection schedule for a hydrocarbon network, according to one or more embodiments of the present disclosure. The method 500 can be implemented by the system 100 and the system 200, as shown in FIGS. 1-3. As such, reference may be made to the examples of FIGS. 1-3 in the description of the method 500. The method 500 can begin at 502 with receiving constraints and parameters (e.g., the input data 104) for a plurality of facilities in a hydrocarbon network. In some embodiments, the constraints and parameters can be submitted by local representatives for each facility in the hydrocarbon network and compiled in a single application (e.g., the unified operations application 202). The constraints and parameters can include the average operating conditions of the facility, specific needs of the facility during turnaround and inspection, interconnected facilities, proposed downtime durations, and other variables affecting the scheduling of maintenance, repairs, and inspection.

The method 500 can continue at 504 with reviewing and validating the input information (e.g., via the data pre-processing and validation module 204) that includes the constraints and parameters. The review and validation at 504 can be performed by director-level personnel within each facility of the hydrocarbon network, as well as by the OSPAS operators, such that quality input data is used in the optimization of the turnaround and inspection schedule. The method 500 can continue at 506 with querying an optimization engine (e.g., the turnaround and inspection optimization engine 102) with the constraints and parameters provided for each of the facilities of the hydrocarbon network. At 506, the optimization engine can utilize parallel processing to enable simultaneous optimization approaches from a linear programming module (e.g., the linear programming module 108) and a genetic algorithm module (e.g., the genetic algorithm module 110). The parallel processing at 506 can enable these simultaneous solution processes while further reducing the computational load on specific processors, as the workload can be distributed across a plurality of physical or virtual processors to increase solution speeds.

The method 500 can continue at 508 with maximizing or minimizing an objective function within the linear programming module. The optimization of the resulting objective function can depend upon the input parameters and constraints, as well as the prioritized design objective provided in the objective function. In some embodiments, the objective function can minimize the total off-line time of the hydrocarbon network, maximize the profitability of the entire hydrocarbon network during turnaround and inspection activities, minimize the hydrocarbon capacity taken offline each day, or a combination thereof. The linear programming module can optimize this objective function at 508 using the constraints and parameters previously provided, such that a first optimized turnaround and inspection schedule can be generated therein.

The method 500 can further include modifying and mutating scheduling solutions in the genetic algorithm module at 510. The modification and mutation of possible scheduling solutions can enable the iterative improvement of these solutions through tuned adjustments and adaptive trial-and-error to achieve further optimized results. The genetic algorithm module can utilize genetic operators to recombine and mutate the proposed solutions, such that the better-fit solutions are maintained and propagated, while failed solutions are weeded out, thus improving any possible solutions for a second optimized turnaround and inspection schedule.

In some embodiments, the method 500 can continue at 512 with facilitating communication between the linear programming module and the genetic algorithm module (e.g., via the information exchange module 112) to improve th initial conditions of both modules. The communication at 512 can provide partially optimized results from the linear programming module to the genetic algorithm module, such that the genetic algorithm module can utilize optimized initial populations or parent populations for further testing. In further embodiments, the communication at 512 can provide iteratively improved, diverse solutions from the genetic algorithm module to the linear programming module, such that the linear programming module can utilize novel approaches to refine the optimization of the objective function.

The method 500 can continue at 514 with testing for convergence (e.g., via the convergence module 114) of both the first and second optimized turnaround and inspection schedule generated via the linear programming module and the genetic algorithm module, respectively. The convergence testing at 514 can include testing for number of iterations, whether a threshold quality has been met, or an overall runtime for each optimizer. If the first and second optimized turnaround and inspection schedule are not converged at 514, the method 500 can continue at 508 with further optimization of the objective function, and can continue through to 514 in a cyclical manner until the first and second optimized turnaround and inspection schedule 118 are converged.

Upon convergence of both optimized turnaround and inspection schedules, the method 500 can continue at 516 with combining (e.g., via the result integration module 116) the converged optimized turnaround and inspection schedules into a final optimized turnaround and inspection schedule (e.g., the optimized turnaround and inspection schedule 118). The combination at 516 can integrate the linear programming solution that has optimized the objective function at 508 with the genetic algorithm solution that has modified and mutated possible solutions to yield an optimized population at 510. Through the combination at 516, the final optimized turnaround and inspection schedule can leverage the power of both linear programming and genetic algorithms in a hybridized manner to provide an ideal schedule for turnaround and inspection of the hydrocarbon network. As such, the final optimized turnaround and inspection schedule can be implemented across the hydrocarbon network to provide necessary repairs, maintenance, and inspections while limiting losses or damages.

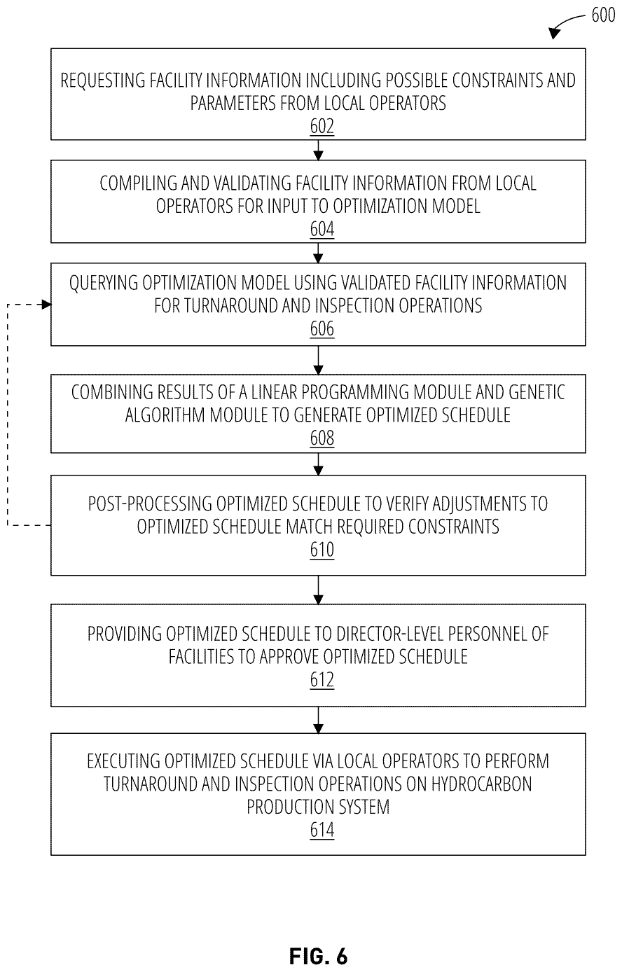

In view of the structural and functional features described above, example methods will be better appreciated with reference to FIG. 6. While, for purposes of simplicity of explanation, the example methods of FIG. 6 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods, and conversely, some actions may be performed that are omitted from the description.

FIG. 6 illustrates a method 600 for planning and executing the optimized turnaround and inspection schedule (e.g., the optimized turnaround and inspection schedule 118) for a hydrocarbon network using a unified operations application (e.g., the unified operations application 202), according to one or more embodiments of the present disclosure. The method 600 can be implemented by the system 100 and system 200, as shown in FIGS. 1-3. As such, reference may be made to the examples of FIGS. 1-3 in the description of the method 600. The method 600 can begin at 602 with requesting facility information for a plurality of hydrocarbon facilities of the hydrocarbon network from local operators of each facility. The facility information requested at 602 can include possible constraints and parameters for creating the optimized turnaround and inspection schedule, such that the needs and capabilities of each facility are captured and accounted for during planning. The requesting at 602 can be performed by OSPAS operators or director-level operators, such that active local operators can provide details about their respective facilities or roles to accurately capture the needs of the facility.

Upon receiving the variety of constraints and parameters from the local operators, the method 600 can continue at 604 with compiling and validating the facility information prior to input to an optimization model. At 604, OSPAS and director-level operators can review the submitted input data, check for validity of the provided estimates/parameters, and coordinate review of any spurious values. The pre-processing and validation at 604 (e.g., via the data pre-processing and validation module 204) can ensure accurate, quality data is used to perform the optimization processes. The method 600 can continue at 606 with querying an optimization model (e.g., the turnaround and inspection optimization engine 102) using the possible constraints and parameters to begin an optimization process. The optimization process at 606 can include both a linear programming module (e.g., the linear programming module 108) and a genetic algorithm module (e.g., the genetic algorithm module 110) to provide a robust, hybridized approach to optimization. At 606, the linear programming module can optimize an objective function based upon a prioritized design objective, such as minimized downtime or maximized profits. Simultaneously at 606, via parallelization, the genetic algorithm module can modify and mutate scheduling solutions to enable the iterative improvement of these solutions through tuned adjustments and adaptive trial-and-error to achieve further optimized results. The genetic algorithm module can utilize genetic operators to recombine and mutate the proposed solutions, such that the better-fit solutions are maintained and propagated, while failed solutions are weeded out.

The method 600 can continue at 608 with combining results of the linear programming module and the genetic algorithm module to construct an optimized turnaround and inspection schedule (e.g., the optimized turnaround and inspection schedule 118. The combination at 608 can integrate the linear programming solution that has optimized the objective function with the genetic algorithm solution that has modified and mutated possible solutions to yield an optimized population. Through this combination, the optimized turnaround and inspection schedule can leverage the power of both linear programming and genetic algorithms in a hybridized manner to provide an ideal schedule for turnaround and inspection of the hydrocarbon network.

The method 600 can continue at 610 with post-processing (e.g., via the data post-processing module 206) the optimized schedule to verify that any adjustments to the proposed schedules acknowledge and account for any local constraints of each facility in the hydrocarbon network. At 610, director-level and OSPAS operators can perform this post-processing and validation to ensure that the optimized turnaround and inspection schedule will be valid for the hydrocarbon network without any unplanned failures or oversights. If any issues are found during the post-processing at 610, the method 600 can continue at 606 with re-querying the optimization model with updated constraints or specific guidance to correct any errors. Otherwise, the method 600 can continue at 612 with providing the optimized schedule to all director-level personnel in charge of each facility in the hydrocarbon network for approval. The optimized schedule can be provided using a unified operations application (e.g., the unified operations application 202), such that a central repository is maintained for data, communication, and scheduling between all facilities and personnel.

Upon approval of the final optimized turnaround and inspection schedule, the method 600 can continue at 614 with executing the optimized schedule via the local operators of each facility to perform repairs, maintenance, and inspections. At 614, the unified operations application can provide the schedule to the local operators, such that all personnel are aware of and follow the optimized schedule. The execution of the optimized turnaround and inspection schedule at 614 can achieve reduced downtime, increased profitability, and proper prioritization of at-risk equipment to improve the turnaround and inspection process throughout the entire hydrocarbon network.

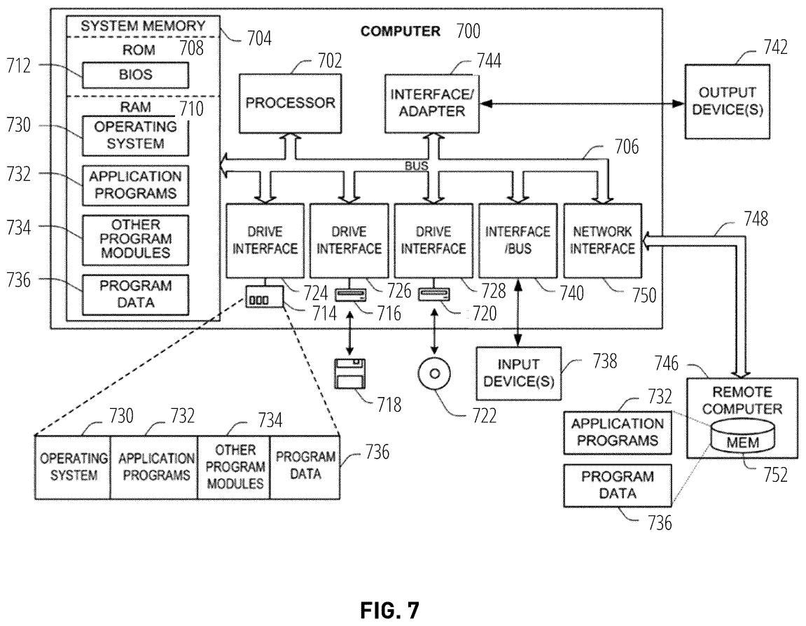

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 7. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard, FIG. 7 illustrates one example of a computer system 700 that can be employed to execute one or more embodiments of the present disclosure. Computer system 700 can be implemented on one or more general purpose networked computer systems, embedded computer systems, routers, switches, server devices, client devices, various intermediate devices/nodes or standalone computer systems. Additionally, computer system 700 can be implemented on various mobile clients such as, for example, a personal digital assistant (PDA), laptop computer, pager, and the like, provided it includes sufficient processing capabilities.

Computer system 700 includes processing unit 702, system memory 704, and system bus 706 that couples various system components, including the system memory 704, to processing unit 702. System memory 704 can include volatile (e.g., RAM, DRAM, SDRAM, Double Data Rate (DDR) RAM, etc.) and non-volatile (e.g., Flash, NAND, etc.) memory. Dual microprocessors and other multi-processor architectures also can be used as processing unit 702. System bus 706 may be any of several types of bus structure including a memory bus or memory controller, a peripheral bus, and a local bus using any of a variety of bus architectures. System memory 704 includes read only memory (ROM) 708 and random access memory (RAM) 710. A basic input/output system (BIOS) 712 can reside in ROM 708 containing the basic routines that help to transfer information among elements within computer system 700.

Computer system 700 can include a hard disk drive 714, magnetic disk drive 716, e.g., to read from or write to removable disk 718, and an optical disk drive 720, e.g., for reading CD-ROM disk 722 or to read from or write to other optical media. Hard disk drive 714, magnetic disk drive 716, and optical disk drive 720 are connected to system bus 706 by a hard disk drive interface 724, a magnetic disk drive interface 726, and an optical drive interface 728, respectively. The drives and associated computer-readable media provide nonvolatile storage of data, data structures, and computer-executable instructions for computer system 700. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and ROM 708, including operating system 730, one or more application programs 732, other program modules 734, and program data 736. In some examples, the application programs 732 can include the turnaround and inspection optimization engine 102, the parallelization module 106, the linear programming module 108, the genetic algorithm module 110, the information exchange module 112, the convergence module 114, the result integration module 116, the unified operations application 202, the data pre-processing and validation module 204, the data post-processing module 206, the refinery management module 302, the facility management module 304, the user creation module 306, the constraint generation module 308, the schedule management module 310 and the schedule approval module 312. The program data 736 can include any of the input data 104, the optimized turnaround and inspection schedule 118, the user credentials, the facility and network data structure, intermediate solutions, and any combination thereof. The application programs 732 and program data 736 can include functions and methods programmed to optimize and execute a turnaround and inspection plan for a hydrocarbon network, such as shown and described herein.

A user may enter commands and information into computer system 700 through one or more input device 738, such as a pointing device (e.g., a mouse, touch screen), keyboard, microphone, joystick, game pad, scanner, and the like. These and other input devices 738 are often connected to processing unit 702 through a corresponding port interface 740 that is coupled to the system bus, but may be connected by other interfaces, such as a parallel port, serial port, or universal serial bus (USB). One or more output devices 742 (e.g., display, a monitor, printer, projector, or other type of displaying device) is also connected to system bus 706 via interface 744, such as a video adapter.

Computer system 700 may operate in a networked environment using logical connections to one or more remote computers, such as remote computer 746. Remote computer 746 may be a workstation, computer system, router, peer device, or other common network node, and typically includes many or all the elements described relative to computer system 700. The logical connections, schematically indicated at 748, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 700 can be connected to the local network through a network interface or adapter 750. When used in a WAN networking environment, computer system 700 can include a modem, or can be connected to a communications server on the LAN. The modem, which may be internal or external, can be connected to system bus 706 via an appropriate port interface. In a networked environment, application programs 732 or program data 736 depicted relative to computer system 700, or portions thereof, may be stored in a remote memory storage device 752.

Embodiments disclosed herein include:
A. A computer-implemented method for executing an optimized turnaround and inspection schedule for a hydrocarbon network including obtaining constraints and parameters related to operations of a plurality of hydrocarbon facilities of the hydrocarbon network, providing the constraints and parameters to a linear programming module and a genetic algorithm module for optimization, optimizing an objective function for a possible turnaround and inspection schedule via the linear programming module and using the constraints and parameters, modifying solutions for the possible turnaround and inspection schedule via genetic operators in the genetic algorithm module, testing for convergence between the linear programming module and the genetic algorithm module, combining the converged solutions of the linear programming module and the genetic algorithm module to generate the optimized turnaround and inspection schedule, and performing maintenance, repairs, and/or inspections on the hydrocarbon facilities according to the optimized turnaround and inspection schedule.
B. A system for constructing an optimized turnaround and inspection schedule for a hydrocarbon network including a turnaround and inspection optimization engine operable to construct an optimized turnaround and inspection schedule from input data including constraints and parameters of a plurality of facilities of the hydrocarbon network. The turnaround and inspection optimization engine includes a linear programming module operable to optimize an objective function using the constraints and parameters of the plurality of facilities, a genetic algorithm module operable to iteratively improve possible solutions to the optimized turnaround and inspection schedule using genetic operators, a convergence module operable to test for convergence in each of the linear programming module and the genetic algorithm module, and a result integration module operable to combine solutions from the linear programming module and the genetic algorithm module to construct the optimized turnaround and inspection schedule.
C. A computer-implemented method for executing an optimized turnaround and inspection schedule for a hydrocarbon network including requesting facility information for a plurality of hydrocarbon facilities of the hydrocarbon network from local operators of each facility, the facility information including possible constraints and parameters for creating the optimized turnaround and inspection schedule, querying an optimization model using the possible constraints and parameters to begin an optimization process on a linear programming module and a genetic algorithm module, constructing the optimized turnaround and inspection schedule from a combination of solutions found via the linear programming module and the genetic algorithm module, and executing the optimized turnaround and inspection schedule on the hydrocarbon network via the local operators of each facility to perform repairs, maintenance, and inspections.

Each of embodiments A through C may have one or more of the following additional elements in any combination: Element 1: further comprising: facilitating communication between the linear programming module and the genetic algorithm module to improve initial conditions used in each module. Element 2: further comprising: receiving the possible turnaround and inspection schedule from the linear programming module within the genetic algorithm module to enhance guidance of the genetic operators. Element 3: further comprising: receiving diverse possible solutions for the possible turnaround and inspection schedule from the genetic algorithm module within the linear programming module to refine optimization of the objective function. Element 4: wherein the linear programming module and the genetic algorithm module operate in parallel to simultaneously perform respective optimization processes. Element 5: further comprising: compiling and validating the constraints and parameters to verify correct input values to the linear programming module and genetic algorithm module. Element 6: further comprising: post-processing the optimized turnaround and inspection schedule to verify that the constraints are accounted for in the optimized turnaround and inspection schedule. Element 7: the turnaround and inspection optimization engine further including: a parallelization module operable to interface with and instruct the linear programming module and genetic algorithm module to perform simultaneous optimization processes. Element 8: the turnaround and inspection optimization engine further including: an information exchange module operable to interface with and exchange information between the linear programming module and genetic algorithm module to provide improved initial conditions for each module.

Element 9: further comprising: a unified operations application operable to facilitate communication between operators of the plurality of facilities of the hydrocarbon network, the unified operations application including: a refinery and facility management module operable to create digital representations of the facilities within the unified operations application by a scheduling operator; a user creation module operable to generate user credentials for director and representative operators at each facility; and a constraint generation module operable to receive the constraints and parameters of each facility from the director and representative users of said facility. Element 10: the unified operations application further comprising: a schedule approval module operable to provide the optimized turnaround and inspection schedule to director and scheduling operators for approval prior to execution. Element 11: the unified operations application further comprising: a schedule management module operable to interface with the turnaround and inspection optimization engine to provide the constraints and parameters to the turnaround and inspection optimization engine and receive the optimized turnaround and inspection schedule. Element 12: further comprising: providing the optimized turnaround and inspection schedule to director-level personnel of each facility for review and approval of the optimized turnaround and inspection schedule. Element 13: further comprising: post-processing the optimized turnaround and inspection schedule to verify that the constraints and parameters are accounted for in the optimized turnaround and inspection schedule. Element 14: wherein the linear programming module and the genetic algorithm module operate in parallel to simultaneously perform respective optimization processes while querying the optimization module. Element 15: further comprising: facilitating communication between the linear programming module and the genetic algorithm module to improve initial conditions used in each module while querying the optimization module. Element 16: further comprising: requesting appointment of local operators for each facility from director-level operators at each facility. Element 17: wherein the parameters and constraints include estimated capacity, estimated downtime, connected facilities, necessary repair operations, operator availability, facility purpose, or any combination thereof.

By way of non-limiting example, exemplary combinations applicable to A through C include: Element 1 with Element 2; Element 1 with Element 3; Element 7 with Element 8; Element 9 with Element 10; Element 9 with Element 11; Element 12 with Element 13; and Element 14 with Element 15.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A computer-implemented method for executing an optimized turnaround and inspection schedule for a hydrocarbon network, the method comprising:
obtaining constraints and parameters related to operations of a plurality of hydrocarbon facilities of the hydrocarbon network;
providing the constraints and parameters to a linear programming module and a genetic algorithm module for optimization;
optimizing an objective function for a possible turnaround and inspection schedule via the linear programming module and using the constraints and parameters;
modifying solutions for the possible turnaround and inspection schedule via genetic operators in the genetic algorithm module;
testing for convergence between the linear programming module and the genetic algorithm module;
combining the converged solutions of the linear programming module and the genetic algorithm module to generate the optimized turnaround and inspection schedule; and
performing maintenance, repairs, and/or inspections on the hydrocarbon facilities according to the optimized turnaround and inspection schedule.

2. The computer-implemented method of claim 1, further comprising:
facilitating communication between the linear programming module and the genetic algorithm module to improve initial conditions used in each module.

3. The computer-implemented method of claim 2, further comprising:
receiving the possible turnaround and inspection schedule from the linear programming module within the genetic algorithm module to enhance guidance of the genetic operators.

4. The computer-implemented method of claim 2, further comprising:
receiving diverse possible solutions for the possible turnaround and inspection schedule from the genetic algorithm module within the linear programming module to refine optimization of the objective function.

5. The computer-implemented method of claim 1, wherein the linear programming module and the genetic algorithm module operate in parallel to simultaneously perform respective optimization processes.

6. The computer-implemented method of claim 1, further comprising:
compiling and validating the constraints and parameters to verify correct input values to the linear programming module and genetic algorithm module.

7. The computer-implemented method of claim 1, further comprising:
post-processing the optimized turnaround and inspection schedule to verify that the constraints are accounted for in the optimized turnaround and inspection schedule.

8. A system for constructing an optimized turnaround and inspection schedule for a hydrocarbon network, the system comprising:
a turnaround and inspection optimization engine operable to construct an optimized turnaround and inspection schedule from input data including constraints and parameters of a plurality of facilities of the hydrocarbon network, the turnaround and inspection optimization engine including:
a linear programming module operable to optimize an objective function using the constraints and parameters of the plurality of facilities;
a genetic algorithm module operable to iteratively improve possible solutions to the optimized turnaround and inspection schedule using genetic operators;
a convergence module operable to test for convergence in each of the linear programming module and the genetic algorithm module; and
a result integration module operable to combine solutions from the linear programming module and the genetic algorithm module to construct the optimized turnaround and inspection schedule.

9. The system of claim 8, the turnaround and inspection optimization engine further including:
a parallelization module operable to interface with and instruct the linear programming module and genetic algorithm module to perform simultaneous optimization processes.

10. The system of claim 9, the turnaround and inspection optimization engine further including:
an information exchange module operable to interface with and exchange information between the linear programming module and genetic algorithm module to provide improved initial conditions for each module.

11. The system of claim 8, further comprising:
a unified operations application operable to facilitate communication between operators of the plurality of facilities of the hydrocarbon network, the unified operations application including:
a refinery and facility management module operable to create digital representations of the facilities within the unified operations application by a scheduling operator;
a user creation module operable to generate user credentials for director and representative operators at each facility; and
a constraint generation module operable to receive the constraints and parameters of each facility from the director and representative users of said facility.

12. The system of claim 11, the unified operations application further comprising:
a schedule approval module operable to provide the optimized turnaround and inspection schedule to director and scheduling operators for approval prior to execution.

13. The system of claim 11, the unified operations application further comprising:
a schedule management module operable to interface with the turnaround and inspection optimization engine to provide the constraints and parameters to the turnaround and inspection optimization engine and receive the optimized turnaround and inspection schedule.

14. A computer-implemented method for executing an optimized turnaround and inspection schedule for a hydrocarbon network, the method comprising:
requesting facility information for a plurality of hydrocarbon facilities of the hydrocarbon network from local operators of each facility, the facility information including possible constraints and parameters for creating the optimized turnaround and inspection schedule;
querying an optimization model using the possible constraints and parameters to begin an optimization process on a linear programming module and a genetic algorithm module;
constructing the optimized turnaround and inspection schedule from a combination of solutions found via the linear programming module and the genetic algorithm module; and
executing the optimized turnaround and inspection schedule on the hydrocarbon network via the local operators of each facility to perform repairs, maintenance, and inspections.

15. The computer-implemented method of claim 14, further comprising:
providing the optimized turnaround and inspection schedule to director-level personnel of each facility for review and approval of the optimized turnaround and inspection schedule.

16. The computer-implemented method of claim 15, further comprising:
post-processing the optimized turnaround and inspection schedule to verify that the constraints and parameters are accounted for in the optimized turnaround and inspection schedule.

17. The computer-implemented method of claim 14, wherein the linear programming module and the genetic algorithm module operate in parallel to simultaneously perform respective optimization processes while querying the optimization module.

18. The computer-implemented method of claim 17, further comprising:
facilitating communication between the linear programming module and the genetic algorithm module to improve initial conditions used in each module while querying the optimization module.

19. The computer-implemented method of claim 14, further comprising:
requesting appointment of local operators for each facility from director-level operators at each facility.

20. The computer-implemented method of claim 14, wherein the parameters and constraints include estimated capacity, estimated downtime, connected facilities, necessary repair operations, operator availability, facility purpose, or any combination thereof.
